(19) United States
(12) Patent Application Publication
(10) Pub. No.: US 2015/0293686 A1
(43) Pub. Date: Oct. 15, 2015

(54) APPARATUS AND METHOD FOR CONTROLLING HOME SCREEN

(71) Applicant: Samsung Electronics Co., Ltd., Gyeonggi-do (KR)

(72) Inventors: Soohyun LEE, Seoul (KR); Seokhee Na, Incheon (KR); Sangki Lee, Seoul (KR); Sukjae Lee, Seoul (KR)

(73) Assignee: Samsung Electronics Co., Ltd.

(21) Appl. No.: 14/683,790

(22) Filed: Apr. 10, 2015

(30) Foreign Application Priority Data
Apr. 10, 2014 (KR) 10-2014-0043189

(51) Int. Cl. G06F 3/0484; G06F 3/041; G06F 3/0488; G06F 3/0482; G06F 3/0483

(52) U.S. Cl. CPC G06F 3/04847; G06F 3/0482; G06F 3/0483; G06F 3/04842; G06F 3/04883; G06F 3/0412

(57) ABSTRACT

A method of and electronic device for controlling a home screen in an electronic device equipped with a touch screen is provided. The method includes detecting whether a selected touch is inputted on the touch screen; displaying a home screen for each use mode when the selected touch is inputted; and controlling a setting of the home screen according to a user's selection. The electronic device includes a touch screen configured to detect whether a selected touch is inputted and display a home screen for each user mode when the selected touch is inputted; and a control module configured to control a setting of the home screen according to a user's selection.

### PRIORITY

This application claims priority under 35 U.S.C. §119(a) to a Korean Patent Application filed on Apr. 10, 2014 in the Korean Intellectual Property Office and assigned Serial No. 10-2014-0043189, the entire contents of which are incorporated herein by reference.

### BACKGROUND

1. Field of the Invention

The present invention relates generally to an apparatus and method for easily controlling a home screen, and more particularly, to an apparatus and method for controlling a home screen that can easily set a home screen by a user, by providing a home screen for each user mode, when a selected touch is input.

2. Description of the Related Art

A portable terminal now provides various services, such as document writing, video editing, wireless Internet, or the like which can be performed by a notebook computer as well as a primary service such as voice calling, text message transmission, and the like, as the function of the portable terminal is gradually developed.

Accordingly, a user's convenience is improved as the portable terminal provides more functions. However, it is disadvantageous in that a user must select a menu multiple times in order to set each function.

In the related art, a user must select a menu multiple times in order to access a home screen. In particular, a home screen having multiple pages is provided. Further, when a page is added to a home screen, an empty default template is provided. Therefore, if pages in a home screen are increased, it is a difficult to find a desired page, and it is impossible to index the home screen for each user mode. Further, pages in a home screen may be configured one at a time, which requires a significant amount of time.

### SUMMARY

The present invention has been made to address the above-mentioned problems and disadvantages, and to provide at least the advantages described above. Accordingly, an aspect of the present invention provides a technology for easily controlling a home screen.

In accordance with an aspect of the present invention, a method of controlling a home screen in an electronic device equipped with a touch screen is provided. The method includes detecting whether a selected touch is inputted on the touch screen; displaying a home screen for each use mode when the selected touch is inputted; and controlling a setting of the home screen according to a user's selection.

In accordance with another aspect of the present invention, an electronic device is provided. The electronic device includes a touch screen configured to detect whether a selected touch is inputted and display a home screen for each user mode when the selected touch is inputted; and a control module configured to control a setting of the home screen according to a user's selection.

### BRIEF DESCRIPTION OF THE DRAWINGS

The above and other aspects, features and advantages of the present invention will be more apparent from the following detailed description, taken in conjunction with the accompanying drawings, in which:

FIG. 1 is a flowchart illustrating a method for controlling a home screen according to an embodiment of the present invention;

FIG. 2 is a diagram illustrating an example of a home screen for each user mode according to an embodiment of the present invention;

FIG. 3 is a diagram illustrating an example of a selected touch according to an embodiment of the present invention;

FIGS. 4A to 4D are diagrams illustrating an example of a home screen according to an embodiment of the present invention;

FIGS. 5 and 6 are diagrams illustrating an example of a home screen according to an embodiment of the present invention; and

FIG. 7 is a block diagram illustrating a configuration of an electronic device according to an embodiment of the present invention.

### DETAILED DESCRIPTION OF EMBODIMENTS OF THE PRESENT INVENTION

Embodiments of the present invention are described with reference to the accompanying drawings in detail. The same reference numbers are used throughout the drawings to refer to the same or like parts. Detailed descriptions of well-known functions and structures incorporated herein are omitted to avoid obscuring the subject matter of the present invention.

An electronic device according to an embodiment of the present invention may be a device including a communication function. For example, the device may include at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Moving Picture Experts Group Audio Layer 3 (MP3) player, a mobile medical device, a camera, or a wearable device (e.g., Head-Mounted-Device (HMD) such as electronic glasses, an electronic garment, an electronic bracelet, an electronic necklace, an electronic accessory, an electronic tattoo, or a smart watch).

According to an embodiment of the present invention, an electronic device may be a smart home appliance including a communication function. For example, the smart home appliance may include at least one of a TeleVision (TV), a Digital Video Disk (DVD) player, an audio device, a refrigerator, an air-conditioner, a vacuum, an oven, a microwave, a washing machine, an air cleaner, a set-top box, a TV box (e.g., Samsung HomeSync™, Apple TV™, or Google TV™), a game console, an electronic dictionary, an electronic key, a camcorder, or an electronic frame.

According to an embodiment of the present invention, an electronic device may include at least one of various medical devices (e.g., Magnetic Resonance Angiography (MRA), Magnetic Resonance Imaging (MRI), Computed Tomography (CT), a scanning machine, an ultrasonic wave device, and the like), a navigation device, a Global Positioning System (GPS) receiver, an Event Data Recorder (EDR), a Flight Data Recorder (FDR), vehicle infotainment device, an electronic equipment for a ship (e.g., navigation equipment for a ship, gyrocompass, or the like), avionics, a security device, a vehicle head unit, or an industrial or household robot.

According to an embodiment of the present invention, an electronic device may include at least one of furniture or a portion of a building/structure that includes a communication function, an electronic board, an electronic signature receiving device, a projector, or various measuring instruments (e.g., water, electricity, gas, or electric wave measuring equipment, and the like). An electronic device according to an embodiment of the present invention may be a combination of at least one of the aforementioned various devices. In addition, it is obvious to those skilled in the art that the electronic device according to an embodiment of the present invention is not limited to the aforementioned devices.

An embodiment of the present invention provides a method and an apparatus for controlling a home screen that can easily set a home screen by a user, by providing a home screen for each user mode, when a selected touch is input.

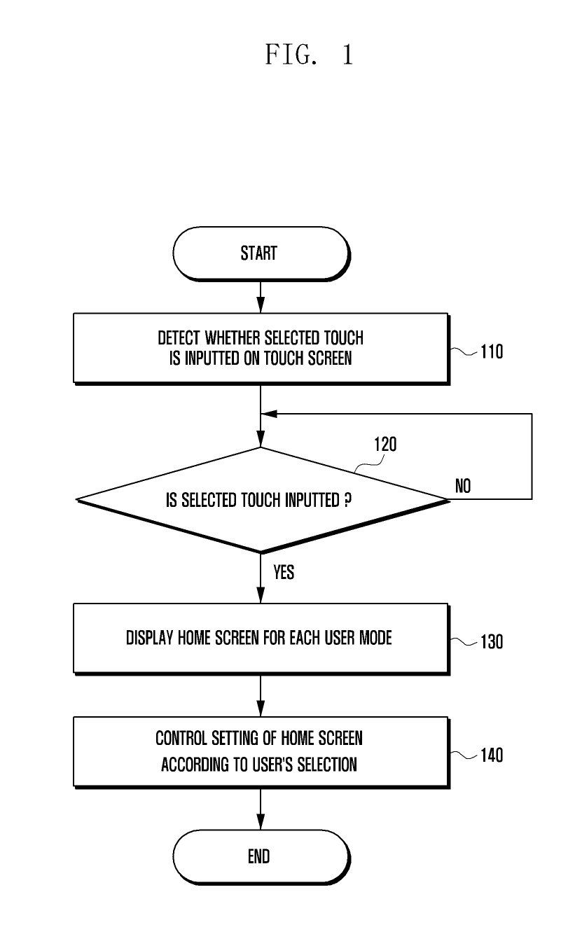

FIG. 1 is a flowchart illustrating a method for controlling a home screen according to an embodiment of the present invention. The method for controlling a home screen of the present invention is performed by an electronic device. The electronic device is equipped with a touch screen.

Referring to FIG. 1, in step 110, the electronic device detects whether a selected touch is inputted on the touch screen. The selected touch is an input for a shortcut to a home screen setting screen in the electronic device, and may be set by default for the electronic device, or set by a user.

According to an embodiment of the present invention, when a touch is moved to a view area of the touch screen from a non-view area of the touch screen, the electronic device determines that the selected touch is inputted. The View Area (VA) is a region for displaying data such as a text, an image, and the like. The non-view area is a bezel area surrounding the periphery of the view area. In general, the non-view area may be printed with at least one combination of various colors such as black, white, pink, and the like so as to cover wiring, a contact, or a pattern. For example, the electronic device may determine that a touch is a selected touch with respect to a touch that moved to a view area from a side of a non-view area, or a touch that moved to a view area from a bottom or a top of a non-view area.

According to an embodiment of the present invention, the electronic device determines that a selected touch is inputted when one or more multi-touches are inputted. A multi-touch refers to touches that are inputted simultaneously at two different coordinates on a touch screen. For example, the electronic device may detect a touch at a first coordinate of a touch screen and a touch at a second coordinate different from the first coordinate, and may determine that the selected touch is inputted, when the touch of the first coordinate and the touch of the second coordinate are moved.

According to an embodiment of the present invention, the electronic device determines that the selected touch is inputted, when a selected area within a view area of the touch screen is touched. The selected area is an area in the view area, and may be set by default in the electronic device, or set by the user.

In step 120, the electronic device determines whether the selected touch is inputted, and performs step 130 when the selected touch is inputted, and performs step 120 when the selected touch is not inputted.

In step 130, the electronic device displays a home screen for each user mode. It is disadvantageous that a user must select a menu multiple times to access a home screen. However, the present invention provides a home screen for each user mode directly when the selected touch is inputted, thereby improving a user's convenience. According to an embodiment of the present invention, the electronic device displays the home screen for each user mode on an entire view area of the touch screen or a portion of the entire view area.

The user mode refers to a mode to provide a home screen suitable to a characteristic of the user using the electronic device. For example, the user mode may be one of a normal mode, an easy mode, a kids mode, or a guest mode. The normal mode is a mode used by general users, and is set by default at the time of manufacture of the electronic device. The easy mode is a mode for a user who has poor eyesight, in which an icon or a font displayed on the electronic device is displayed larger than in the normal mode. The kids mode is a mode for a young user, and includes only a function suitable to kids and not unsuitable services such as a phone call, a payment, and the like. The guest mode is a mode for another user other than the original owner of the electronic device, and includes only functions than do not disclose personal information of the owner (e.g., contact, notepad, photo, or the like). The functions included in the user mode are set by default in the electronic device, or may be set by the user.

The home screen includes a home screen which is specialized according to the user mode. For example, the home screen of the easy mode is displayed relatively larger than the home screen of the normal mode. The home screen of the kids mode is displayed simply and easily as compared to the home screen of the normal mode. The home screen of the guest mode is displayed with a home screen including a function except at least one function (e.g., at least one of contact, notepad, or photo) included in the home screen of the normal mode.

According to an embodiment of the present invention, the electronic device displays a home screen for each subject. The subject refers to a classification to provide a home screen suitable for the characteristic of a field in which a user is interested. For example, the subject may include various fields such as basic, entertainment, camera, travel, and the like. The basic field is a default mode similar to the normal mode, and may be a mode set by default when the electronic device is manufactured. The entertainment field provides a home screen that includes a function, an application, and content related to entertainment. The camera field provides a home screen that includes a function, an application, and content related to a camera. The travel field provides a home screen that includes a function, an application, and content related to travel.

According to an embodiment of the present invention, the electronic device displays a home screen of a first user mode and the items of another user mode, or may display the home screen and a scroll of the first user mode. When a touch is inputted to the home screen, the electronic device displays another home screen included in the first user mode. Alternatively, when any one of the items of another user mode is selected, the electronic device displays the home screen of the other user mode. When a touch is inputted to the scroll, the electronic device displays the home screen of another user mode.

In step 140, the electronic device controls the setting of the home screen according to a user's selection. According to an embodiment of the present invention, the electronic device controls any setting among addition, deletion, and editing of the home screen of the user mode selected by the user. In detail, when the user selects “addition,” the electronic device searches the content related to the additionally requested user mode based on a user history, and displays a recommended home screen template including the searched content. That is, the electronic device does not merely provide a blank template, but provides a recommended home screen template specialized for each user according to the user history, thereby improving the user's convenience.

Alternatively, when the user selects “addition”, the electronic device displays a default home screen template related to the additionally requested user mode, and receives a selection of the content to be added to the default home screen template from the user. When the content is not searched based on the user history, or when the user selects an empty template, the electronic device provides the default home screen template, so that the user may be able to insert the desired content into the default home screen template.

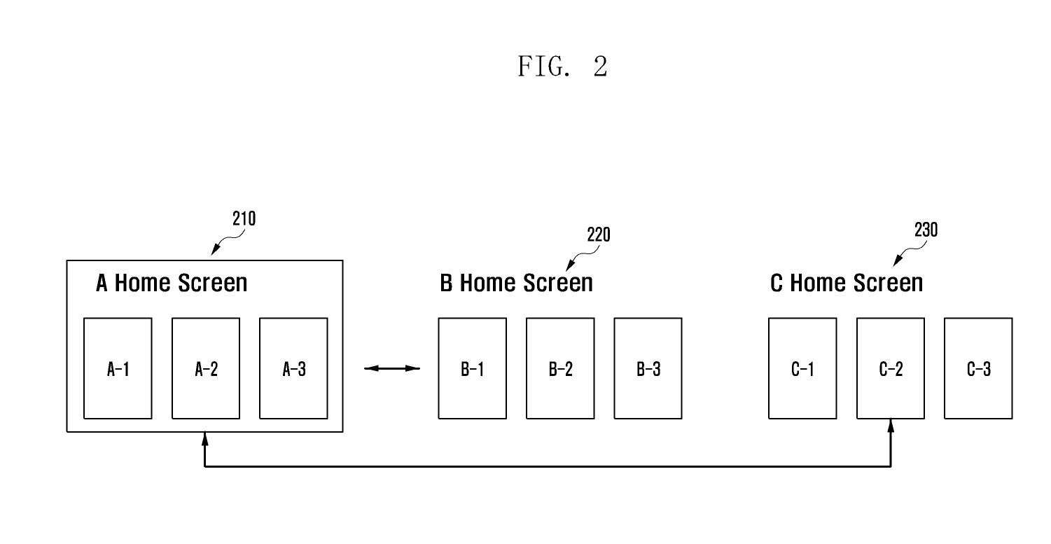

FIG. 2 is a diagram illustrating an example of a home screen for each user mode according to an embodiment of the present invention.

Referring to FIG. 2, the electronic device includes respective home screens for each user mode. For example, the electronic device includes home screen A 210, home screen B 220, and home screen C 230. One home screen has one group according to the subject or the user mode. The one group may include a plurality of pages. For example, home screen A 210 includes pages A-1 to A-3, home screen B 220 includes pages B-1 to B-3, and home screen C 230 includes pages C-1 to C-3. In the present invention, when the selected touch is inputted, as shown in FIG. 2, the home screen for each user mode is displayed.

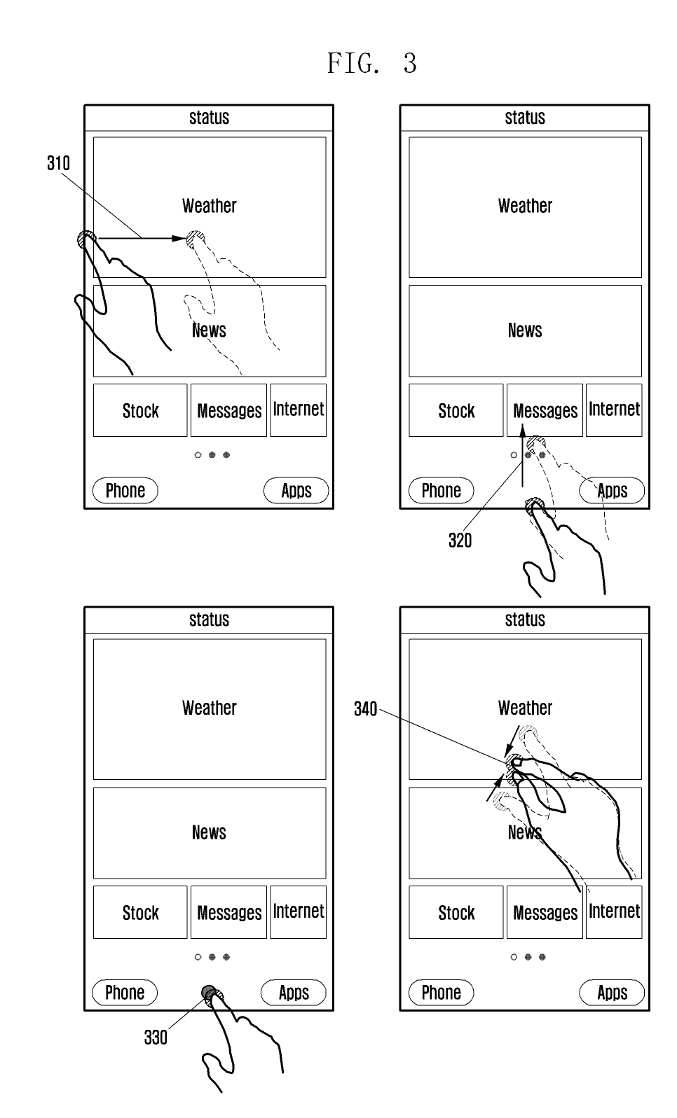

FIG. 3 is a diagram illustrating an example of a selected touch according to an embodiment of the present invention.

Referring to FIG. 3, the electronic device sets a selected touch to go directly to a home screen setting screen. The selected touch may be set in the electronic device by default, or may be set by the user. According to an embodiment of the present invention, the electronic device may set at least one of a touch that moves from the non-view area of the touch screen to the view area of the touch screen, one or more multi-touches, or a touch detected in a selected area, as the selected touch. For example, the electronic device may set a touch 310 that moves from a side of a non-view area to a view area as the selected touch. Alternatively, the electronic device may set a touch 320 that moves from the bottom of a non-view area to a view area as the selected touch. Alternatively, the electronic device may set a touch that moves from the top of a non-view area to a view area as the selected touch. Alternatively, the electronic device may set a touch 330 detected in a selected area within the view area of the touch screen as the selected touch. Alternatively, the electronic device may set a multi touch 340 having a touch of a first coordinate of the touch screen and a touch of a second coordinate different from the first coordinate that moves in a certain direction as the selected touch. The multi touch 340 may be a pinch touch. For example, the multi touch 340 may be two touches, which are simultaneously detected at different points, that are zoomed-in, zoomed-out, or twisted.

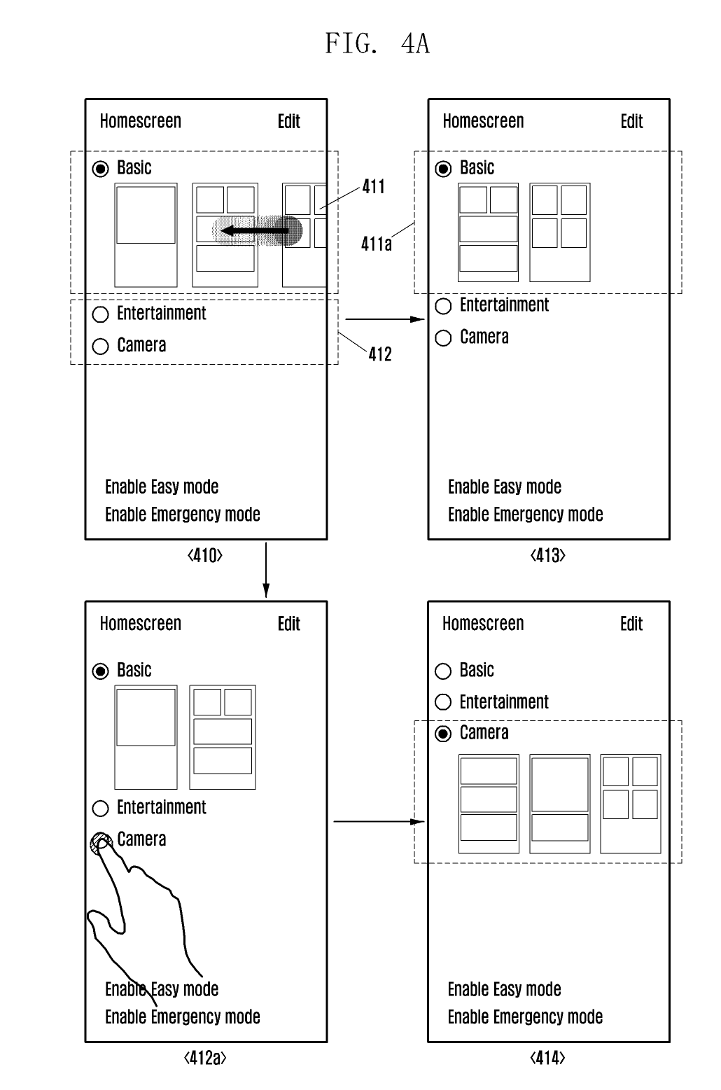

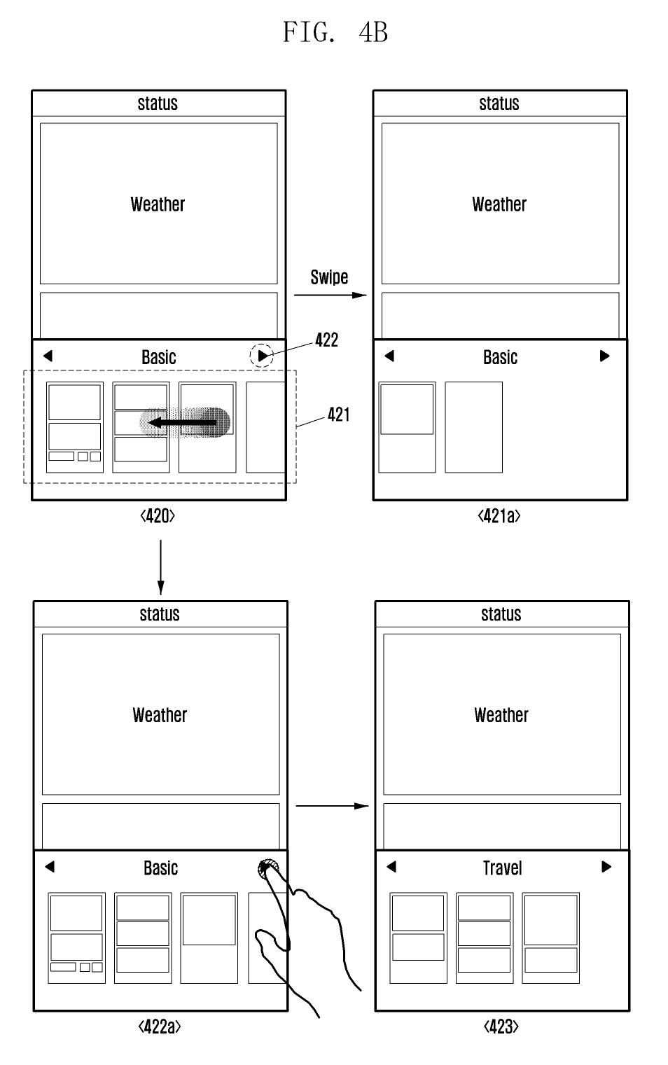

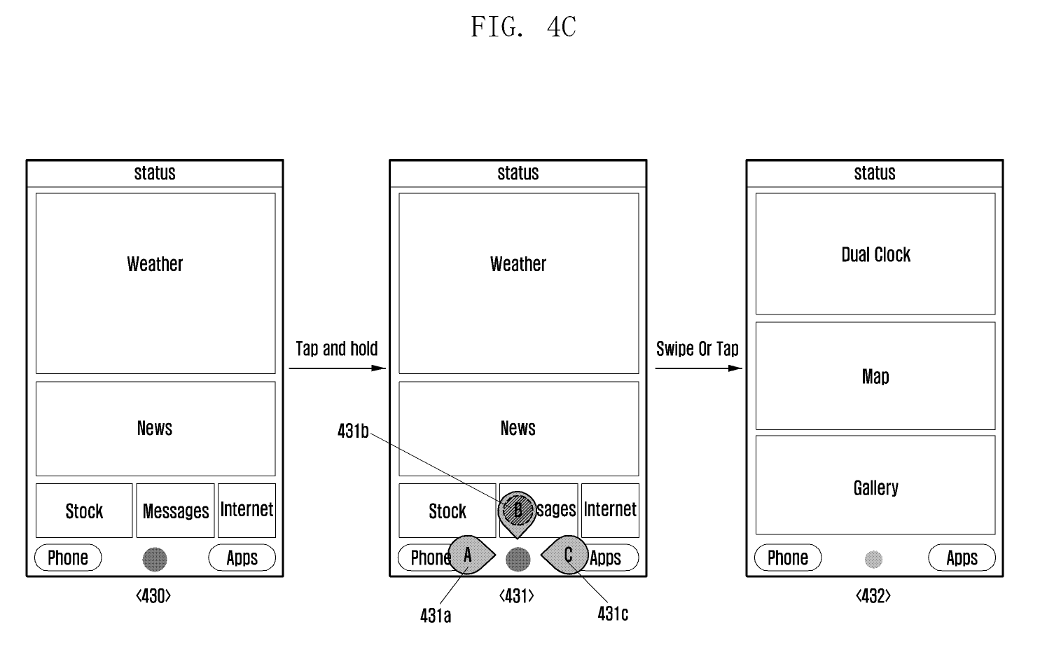

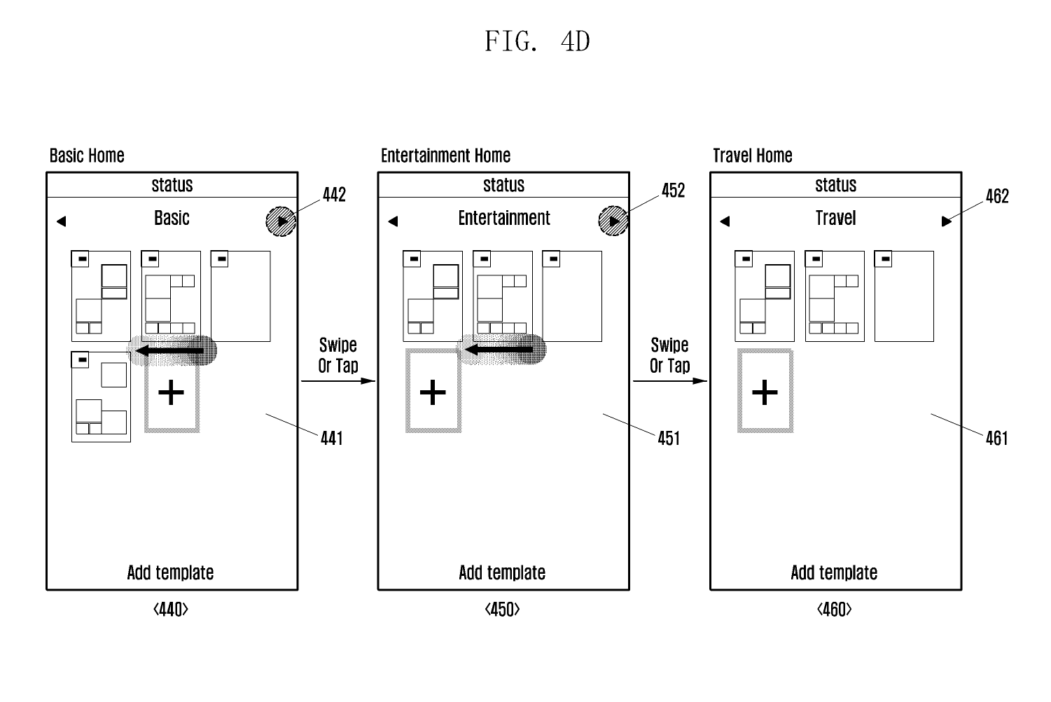

FIGS. 4A to 4D are diagrams illustrating an example of a home screen according to an embodiment of the present invention. When the selected touch is inputted, the electronic device displays a home screen for each user mode.

Referring to FIG. 4A, according to an embodiment of the present invention, the electronic device displays a home screen 411 of a first user mode (e.g. Basic) and items 412 of another user mode in diagram section 410. In this case, when a touch is inputted to the home screen 411, the electronic device displays a different home screen 411a included in the first user mode in diagram section 413. The touch inputted to the home screen 411 may be a touch that moves in a left or a right direction. Alternatively, the electronic device receives a selection of any one item 412a among items 412 of the other user mode. In this case, the electronic device displays the home screen of the other user mode in diagram section 414. According to an embodiment of the present invention, the electronic device displays the home screen 411 of the first user mode and the items 412 of the other user mode on the entire view area of the touch screen in diagram section 410. The electronic device displays a screen as shown in FIG. 4A with respect to the touch that moves from the side of the non-view area to the view area.

Referring to FIG. 4B, according to an embodiment of the present invention, the electronic device displays a home screen 421 of a first user mode (e.g. Basic) and a scroll 422 in diagram section 420. In this case, when a touch is inputted to the home screen 421, the electronic device display a different home screen 421a included in the first user mode. The touch inputted to the home screen 421 may be a touch that moves in a left or a right direction. Alternatively, when a touch is inputted to the scroll 422, the electronic device displays a home screen (e.g. diagram section 423, Travel) of another user mode in diagram section 422a. According to an embodiment of the present invention, the electronic device displays the home screen 421 of the first user mode and the scroll 422 on a view area of the entire view area in diagram section 420. The electronic device displays a screen as shown in FIG. 4B with respect to a touch that moves from the bottom of the non-view area to the view area.

Referring to FIG. 4C, according to an embodiment of the present invention, when a selected area within the view area is touched in diagram section 430, the electronic device displays a label (e.g. 431a to 431c) for each user mode in diagram section 431. The label may be displayed by at least one of a symbol, a name, an image, or an icon that signifies each home screen. For example, the electronic device may display a label of a home screen 431a of the first user mode, a label of a home screen 431b of a second user mode, and a label of a home screen 431c of a third user mode. Then, when any one label 431b among the displayed labels (e.g. 431a to 431c) is selected, the electronic device displays a home screen in diagram section 432 related to the user mode of the selected label 431b. According to an embodiment of the present invention, the electronic device displays a label (e.g. 431a to 431c) for each user mode on a certain view area of the entire view area in diagram section 431. The electronic device displays a screen as shown in FIG. 4C with respect to a touch detected in a selected area within the view area.

Referring to FIG. 4D, according to an embodiment of the present invention, the electronic device displays a home screen 441 of a first user mode and a scroll 442 in diagram section 440. In this case, when a touch is inputted to the home screen 441, the electronic device displays a different home screen included in the first user mode. The touch inputted to the home screen 441 may be a touch that moves in a left or a right direction. Alternatively, when a touch is inputted to the scroll 442, the electronic device displays a home screen of a second user mode (e.g. 451, Entertainment), and a scroll 452 in diagram section 450. When a touch is inputted to the scroll 452, the electronic device displays a home screen of a third user mode (e.g. 461, Travel), and a scroll 462 in diagram section 460. According to an embodiment of the present invention, the electronic device displays the home screen 441 of the first user mode and the scroll 442 on the entire view area in diagram section 440. The electronic device displays a screen as shown in FIG. 4D with respect to a multi-touch.

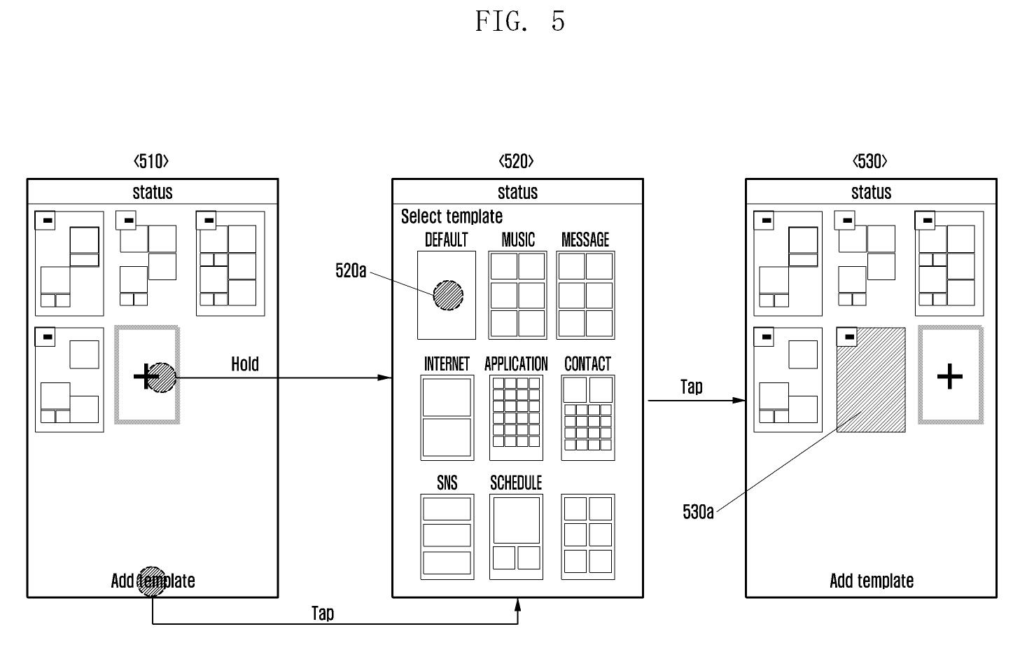

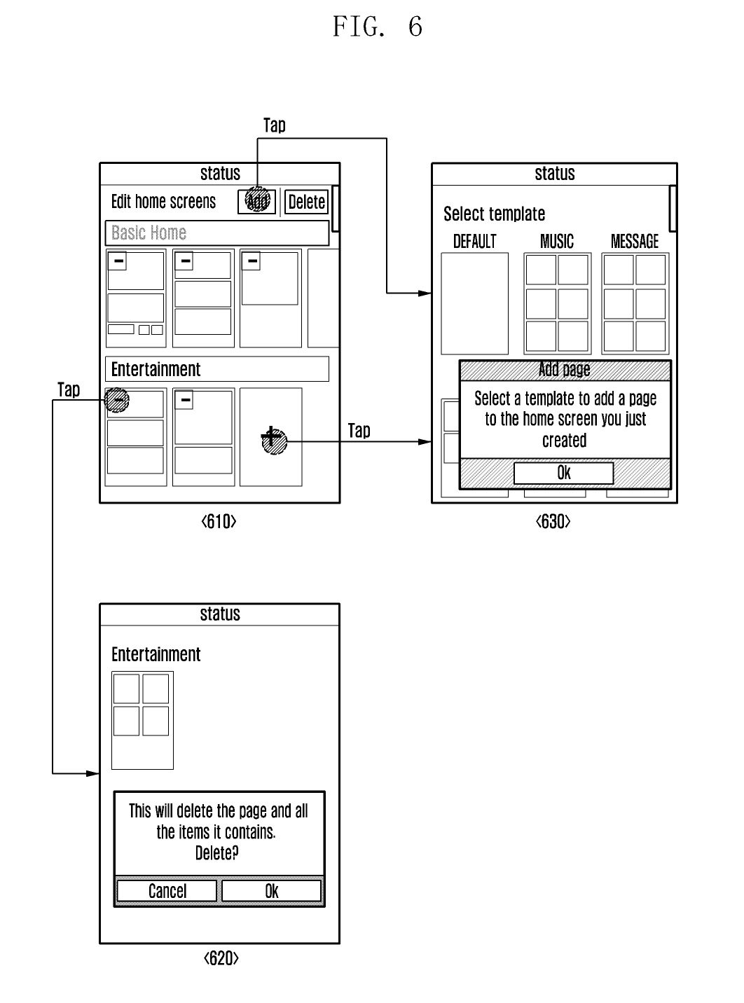

FIGS. 5 and 6 are diagrams illustrating an example of a home screen according to an embodiment of the present invention. The electronic device controls any one setting among addition, deletion, and editing of the home screen of a user mode selected by the user.

Referring to FIG. 5, the electronic device receives a selection of “addition” on the home screen related with a user mode in diagram section 510. The addition may be implemented by selecting “+” on the home screen, or selecting “Add template.” The electronic device searches the content related with the additionally requested user mode based on user history, and displays the recommended home screen template that includes the searched content in diagram section 520. Then, the electronic device displays the recommended home screen template and the default home screen template (e.g. DEFAULT) simultaneously. The recommended home screen template may be specialized according to the content (e.g., music, message, Internet, application, contact, Social Networking Service (SNS), schedule, etc.). The layout of the default home screen template and the recommended home screen template may be implemented by considering the characteristic of the additionally requested home screen.

Conventionally, when one page is added to the home screen, an empty default template is provided. Therefore, if the number of page in the home screen is increased, it is disadvantageous in that it is difficult to find a desired page, difficult to index the home screen for each user mode, and takes a significant amount of time as pages may be configured one at a time within a home screen. However, an embodiment of the present invention does not merely provide a blank template, but provides a recommended home screen template specialized for each user according to user history, thereby improving the user's convenience. Alternatively, the electronic device displays the default home screen template related to the additionally requested user mode, and receives a selection of the content to be added to the default home screen template from the user. That is, when the content is not searched based on user history, or when the user selects an empty template, the electronic device provides a default home screen template, so that the user may insert a desired content to the default home screen template. When the default home screen template is selected 520a, the electronic device adds the default home screen template 530a to the home screen in diagram section 530.

Referring to FIG. 6, the electronic device displays a page included in the home screen for each user mode in diagram section 610. In this case, when “deletion” (e.g. “−”) is selected, the electronic device deletes the page, which is requested to delete, from a home screen (e.g. Entertainment) in diagram section 620. Alternatively, when “addition” (e.g. “+”) is selected, the electronic device displays the default home screen template and the recommended home screen template, so that the template selected by the user may be added to the home screen (e.g. Entertainment). The basic layout of the default home screen template and the recommended home screen template may be implemented by considering the characteristic of the home screen of “Entertainment.”

According to an embodiment of the present invention, the home screen control method includes an operation of detecting whether a selected touch is inputted on the touch screen, displaying a home screen for each use mode, when the selected touch is inputted, and controlling a setting of the home screen according to a user's selection.

The operation of detecting whether a selected touch is inputted includes determining that the selected touch is inputted when a touch is moved from a non-view area surrounding a view area of the touch screen to the view area.

The operation of detecting whether a selected touch is inputted includes determining that the selected touch is inputted when one or more multi-touches are inputted.

The operation of determining that the selected touch is inputted includes detecting a touch in a first coordinate of the touch screen and a second coordinate different from the first coordinate, and determining that the selected touch is inputted when the touch of the first coordinate and the touch of the second coordinate are moved.

The operation of detecting whether a selected touch is inputted includes determining that the selected touch is inputted when a selected area within the view area is touched on the touch screen.

The operation of displaying a home screen includes displaying a label for each user mode, and displaying a home screen related with a user mode of a selected label when any one of the displayed labels is selected.

The operation of displaying a home screen includes displaying a home screen for each user mode on an entire view area of the touch screen or a certain view area of the entire view area.

The operation of displaying a home screen includes displaying a home screen for each subject.

The operation of displaying a home screen includes displaying a home screen of a first user mode and items of another user mode or displaying a home screen of a first user mode and a scroll.

The operation of displaying a home screen includes at least one of displaying the other home screen included in the first user mode when a touch is inputted on the home screen, displaying a home screen of the other user mode when one of the items of the other user mode is selected, or displaying a home screen of the other user mode when a touch is inputted to the scroll.

The operation of controlling a setting of the home screen includes controlling a setting of any one of addition, deletion, and an editing of a home screen of the user mode selected by the user.

The operation of the addition includes searching a content related with an additionally requested user mode based on a user history, and displaying a recommended home screen template including the searched content.

The operation of addition includes displaying a default home screen template related to the additionally requested user mode, and receiving a selection of content to be added to the default home screen template from the user.

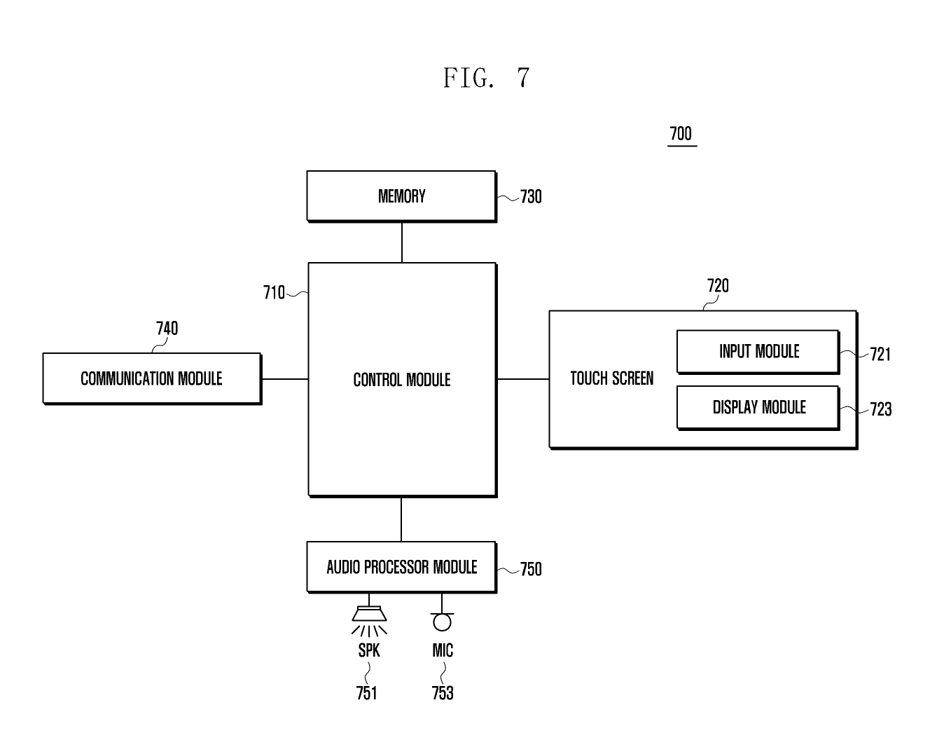

FIG. 7 is a block diagram illustrating a configuration of an electronic device 700 according to an embodiment of the present invention.

Referring to FIG. 7, the electronic device 700 includes a control module 710, a touch screen 720, a memory 730, a communication module 740, and an audio processor module 750.

The touch screen 720 detects whether a selected touch is inputted, and displays a home screen for each mode when the selected touch is inputted. The touch screen 720 displays a home screen for each subject. The selected touch is an input for a shortcut to a home screen setting screen in the electronic device 700, and may be set in the electronic device 700 by default, or set by a user. The touch screen 720 may be configured by an integrated type of an input module 721 and a display module 723. The input module 721 may include a plurality of keys for inputting numeral or character information and setting various functions. The keys may include a menu import key, a screen on/off key, a power on/off key, a volume control key, and the like

The input module 721 generates a key event related to the user setting and the function control of the electronic device 700 and transfers it to the control module 710. The key events include a power on/off event, a volume control event, a screen on/off event, a shutter event, and the like. The display module 723 displays an image on a screen on which at least one image is shown under the control of the control module 710. That is, when the control module 710 processes (e.g., decodes) data into an image to be displayed on the screen and stored in a buffer, the display module 723 converts the image stored in the buffer into an analog signal and displays it on the screen. The display module 723 may be configured as a Liquid Crystal Display device (LCD), an Organic Light Emitted Diode (OLED), an Active Matrix Organic Light Emitted Diode (AMOLED), or a flexible display.

According to an embodiment of the present invention, the touch screen 720 displays a label for each user mode, and displays a home screen related to the user mode of a selected label, when any label is selected from among the displayed labels. Alternatively, the touch screen 720 displays a home screen for each user mode on an entire view area or a certain view area of the entire view area. The touch screen 720 displays the home screen of a first user mode and the items of another user mode, or the home screen and the scroll of the first user mode. The touch screen 720 performs at least one of 1) displaying a different home screen included in the first user mode when a touch is inputted on the home screen, 2) displaying a home screen of another user mode when any item is selected from among items of the other user mode, and 3) displaying a home screen of another user mode when a touch is inputted to the scroll.

The control module 710 determines that the selected touch is inputted when the touch is moved from the non-view area of the touch screen 720 to the view area or when a selected area within the view area is touched. Alternatively, the control module 710 detects a touch on a first coordinate of the touch screen 720 and a second coordinate different from the first coordinate, and determines that the selected touch is inputted when the touch of the first coordinate and the touch of the second coordinate are moved. The view area is an area that displays data such as a text, an image, or the like. The non-view area is a bezel area surrounding the periphery of the view area. The control module 710 controls the setting of the home screen according to a user's selection.

The control module 710 controls an overall operation of the electronic device 700 and a signal flow between internal configurations of the electronic device 700, performs a function for processing data, and controls the power supplied to the configurations from a battery. The control module 710 includes a Central Processing Unit (CPU) and a Graphics Processing Unit (GPU). The CPU is a control unit of a computer system that performs a calculation and a comparison of data, and an interpretation and an execution of a command. The GPU is a graphics control unit that performs a calculation and a comparison of data related to a graphic, and an interpretation and an execution of a command. The CPU and the GPU may be integrated into a package in which two or more independent cores (e.g., a quad-core) are implemented by a single integrated circuit or chip. In addition, the CPU and the GPU may be integrated into a single chip (i.e., a System on Chip (SoC)). In addition, the CPU and the GPU may be packaged with a multi layer. The configuration including the CPU and the GPU may be referred to as an Application Processor (AP).

The control module 710 controls any setting among addition, deletion, and editing of the home screen of the user mode selected by the user. For example, the control module 710 controls the display of the default home screen template related to the additionally requested user mode on the touch screen 720, or searches the content related to the additionally requested user mode based on a user history, and displays a recommended home screen template including the searched content on the touch screen 720.

The memory 730 stores software required for the operation of the electronic device 700, and various data received or generated by the use of the electronic device 700. The memory 730 includes digital storage from which the control module 710 can read or to which the control module 710 can write. One or more programs may be stored in the memory 730 in order to perform functions. The memory 730 may be a secondary memory unit of the control module 710, and may include a disk, a Random Access Memory (RAM), a Read Only Memory (ROM), a flash memory, and the like. The memory 730 stores data (e.g., contact) generated by the electronic device 700 and data (e.g., a message, a video file) received from an external device via the communication module 740. The memory 730 includes size information of an image (e.g., a keypad, a video, a message, etc.) and view area information of an image.

The communication module 740 performs a voice call, a video call, or a data communication with an external device via a network, under the control of the control module 710. The communication module 740 includes a wireless frequency transmission unit for up-converting and amplifying a frequency of a transmitted signal, and a wireless frequency reception unit for low-noise amplifying and down-converting a frequency of a received signal. In addition, the communication module 740 includes a mobile communication module (e.g., a 3rd Generation mobile communication module, a 3.5 Generation mobile communication module, or a 4th Generation mobile communication module, and the like), a digital broadcast module (e.g., Digital Multimedia Broadcasting (DMB) module), and a short range communication module (e.g., a Wireless Fidelity (Wi-Fi) module, a Bluetooth module, a Near Field Communication (NFC) module).

The audio processor module 750 includes a MICrophone (MIC) 753 and a SPeaKer (SPK) 751. The audio processor module 750 performs the input and the output of an audio signal (e.g., voice data) for voice recognition, voice recording, digital recording, and calling, in combination with the speaker (SPK) 751 and the microphone (MIC) 753. The audio processor module 750 receives the audio signal from the control module 710, Digital-to-Analog (D/A) converts the received audio signal into an analog signal, and amplifies the converted signal to output to the speaker (SPK) 751. The audio processor module 750 Analog-to-Digital (A/D) converts the audio signal received from the microphone (MIC) 753 into a digital signal to provide to the control module 710. The speaker (SPK) 751 converts the audio signal into a sound wave and outputs the sound wave. The microphone (MIC) 753 converts a sound wave transmitted from a person or other sound sources into an audio signal.

The electronic device 700 according to an embodiment of the present invention includes a touch screen to detect whether a selected touch is inputted and display a home screen for each user mode when the selected touch is inputted, and a control module to control a setting of the home screen according to a user's selection.

The control module determines that the selected touch is inputted when a touch is moved from a non-view area of the touch screen to a view area or when a selected area within the view area is touched.

The control module detects a touch in a first coordinate of the touch screen and a second coordinate different from the first coordinate and determines that the selected touch is inputted when the touch of the first coordinate and the second coordinate are moved.

The touch screen displays a label for each user mode, a home screen related to a user mode of a selected label when any label of the displayed labels is selected, or a home screen for each user mode on an entire view area of the electronic device or a certain view area of the entire view area.

The touch screen displays a home screen for each subject.

The touch screen displays a home screen of a first user mode and items of another user mode or displays a home screen of a first user mode and a scroll.

The touch screen performs at least one of 1) displaying another home screen included in the first user mode when a touch is inputted on the home screen, 2) displaying a home screen of another user mode when one of the items of the other user mode is selected, or 3) displaying a home screen of the other user mode when a touch is inputted to the scroll.

The control module controls a setting of any of addition, deletion, and editing of a home screen of a user mode selected by the user.

The control module controls the display of a default home screen template related to an additionally requested user mode on the touch screen, search a content related to an additionally requested user mode based on a user history, and display a recommended home screen template including the searched content on the touch screen.

According to an embodiment of the present invention, a user may easily set a home screen.

Although embodiments of the present invention have been described in detail hereinabove, it should be clearly understood that many variations and modifications of the basic inventive concepts herein taught which may appear to those skilled in the present art will still fall within the scope and spirit of the present invention, as defined in the appended claims and their equivalents.

What is claimed is:

1. A method of controlling a home screen in an electronic device equipped with a touch screen, the method comprising:
detecting whether a selected touch is inputted on the touch screen;
displaying a home screen for each use mode when the selected touch is inputted; and
controlling a setting of the home screen according to a user's selection.

2. The method of claim 1, wherein detecting whether the selected touch is inputted comprises determining that the selected touch is inputted when a touch is moved from a non-view area surrounding a view area of the touch screen to the view area.

3. The method of claim 1, wherein detecting whether the selected touch is inputted comprises determining that the selected touch is inputted when one or more multi-touches are inputted.

4. The method of claim 1, wherein determining that the selected touch is inputted comprises:
detecting a touch in a first coordinate of the touch screen and a touch in a second coordinate different from the first coordinate; and
determining that the selected touch is inputted when the touch of the first coordinate and the touch of the second coordinate are moved.

5. The method of claim 1, wherein detecting whether the selected touch is inputted comprises determining that the selected touch is inputted when a selected area is touched within a view area of the touch screen.

6. The method of claim 5, wherein displaying the home screen comprises:
displaying a label for each user mode; and
displaying a home screen related with a user mode of a selected label when a displayed label is selected.

7. The method of claim 1, wherein displaying the home screen comprises displaying a home screen for each user mode on an entire view area of the touch screen or a certain view area of the entire view area.

8. The method of claim 1, wherein displaying the home screen comprises displaying a home screen for each subject.

9. The method of claim 1, wherein displaying the home screen comprises displaying a home screen of a first user mode and items of another user mode or displaying the home screen of the first user mode and a scroll.

10. The method of claim 9, wherein displaying the home screen comprises at least one of:
displaying another home screen included in the first user mode when a touch is inputted on the home screen;
displaying the home screen of the another user mode when one of the items of the another user mode is selected; or
displaying a home screen of the another user mode when a touch is inputted to the scroll.

11. The method of claim 1, wherein controlling the setting of the home screen comprises controlling a setting of one of addition, deletion, and editing of the home screen of a user mode selected by the user.

12. The method of claim 11, wherein addition comprises:
searching a content related with an additionally requested user mode based on a user history; and
displaying a recommended home screen template including the searched content.

13. The method of claim 11, wherein addition comprises:
displaying a default home screen template related with an additionally requested user mode; and
receiving a selection of content to be added to the default home screen template from the user.

14. An electronic device, comprising:
a touch screen configured to detect whether a selected touch is inputted and display a home screen for each user mode when the selected touch is inputted; and
a control module configured to control a setting of the home screen according to a user's selection.

15. The electronic device of claim 14, wherein the control module is further configured to determine that the selected touch is inputted when a touch is moved from a non-view area of the touch screen to a view area or when a selected area within the view area is touched, or detect a touch in a first coordinate of the touch screen and a touch in a second coordinate different from the first coordinate, and determine that the selected touch is inputted when the touch of the first coordinate and the touch of the second coordinate are moved.

16. The electronic device of claim 14, wherein the touch screen is further configured to display a label for each user mode, display a home screen related with a user mode of a selected label when a displayed label is selected, or display a home screen for each user mode on an entire view area of the electronic device or a certain view area of the entire view area, or display a home screen for each subject.

17. The electronic device of claim 14, wherein the touch screen is further configured to display a home screen of a first user mode and items of another user mode, or display a home screen of the first user mode and a scroll.

18. The electronic device of claim 17, wherein the touch screen is further configured to perform at least one of:
displaying another home screen included in the first user mode when a touch is inputted on the home screen,
displaying a home screen of the another user mode when one of the items of the another user mode is selected, or
displaying a home screen of the another user mode when a touch is inputted to the scroll.

19. The electronic device of claim 14, wherein the control module is further configured to control a setting of any of addition, deletion, and editing of the home screen of a user mode selected by the user.

20. The electronic device of claim 19, wherein the control module is further configured to control displaying a default home screen template related to an additionally requested user mode on the touch screen, searching a content related to an additionally requested user mode based on a user history, and displaying a recommended home screen template including the searched content on the touch screen.
